(19) United States
(12) Patent Application Publication
(10) Pub. No.: US 2013/0076471 A1
(43) Pub. Date: Mar. 28, 2013

(54) TRANSFORMER AND ASSEMBLING METHOD THEREOF

(71) Applicants: CHUN-KONG CHAN, NEW TAIPEI CITY (TW); KED-LAN HUANG, NEW TAIPEI CITY (TW); CHI-FANG LAI, NEW TAIPEI CITY (TW)

(72) Inventors: CHUN-KONG CHAN, NEW TAIPEI CITY (TW); KED-LAN HUANG, NEW TAIPEI CITY (TW); CHI-FANG LAI, NEW TAIPEI CITY (TW)

(73) Assignee: LIEN CHANG ELECTRONIC ENTERPRISE CO., LTD., NEW TAIPEI CITY (TW)

(21) Appl. No.: 13/241,218

(22) Filed: Sep. 23, 2011

(51) Int. Cl. H01F 27/29

(52) U.S. Cl. 336/192

(57) ABSTRACT

A transformer includes a winding frame, a primary coil, an insulating cover, a secondary coil, and a core assembly. The winding frame has a winding portion formed with a first side portion and a second side portion oppositely. A plurality of first pins and second pins are disposed on the first and second side portions, respectively. The primary coil is wrapped around the winding portion of the winding frame and connected to the first pins. The insulating cover is fitted over the primary coil. The secondary coil is wrapped around the insulating cover and connected to the second pins. The core assembly is arranged on the winding frame. A transformer assembling method is also disclosed. The coil wrapping process for the transformer can be expedited and associated cost can be reduced.

### BACKGROUND OF THE INVENTION

1. Field of the Invention

The instant disclosure relates to a transformer and an assembling method thereof; and more particularly, to a transformer having improved isolating arrangements for separating a primary coil and a secondary coil disposed thereon.

2. Description of Related Art

In general, transformers are necessary to convert alternating current from one voltage to another to power most electronic devices. A conventional transformer comprises a winding frame, a primary coil wrapped around the winding frame, a secondary coil wrapped around the primary coil, and a core assembly arranged onto the winding frame. To separate the primary coil from the secondary coil, after the primary coil has been wrapped around the winding frame, an insulating tape must be applied over the primary coil before the wrapping of the secondary coil.

### SUMMARY OF THE INVENTION

The instant disclosure provides a transformer and an assembling method thereof. A disposition of a primary coil and a secondary coil of the transformer can be managed by a single winding machine in a smooth and cost-saving manner.

The transformer comprises the following: a winding frame having a winding portion, which is formed with a first side portion and a second side portion oppositely; a plurality of first pins disposed on the first side portion and a plurality of second pins disposed on the second side portion; a primary coil wrapped around the winding portion of the winding frame and in contact with the first pins; an insulating cover to fit over the primary coil; a secondary coil wrapped around the insulating cover and in contact with the second pins; and a core assembly arranged on the winding frame.

The transformer assembling method of the instant disclosure comprises the following steps: providing a winding frame having a winding portion, a first side portion, and a second side portion, with the first side portion having a plurality of first pins disposed thereon, and the second side portion having a plurality of second pins disposed thereon; wrapping a primary coil around the winding portion of the winding frame and connecting the primary coil to the first pins; covering the primary coil with an insulating cover; wrapping a secondary coil around the insulating cover and connecting the secondary coil to the second pins; and arranging a core assembly on the winding frame.

For the instant disclosure, the insulating cover can be easily installed over the primary coil. A fully automatic winding machine may be used to wrap the primary coil and secondary coil in a one-step process. The above capabilities expedite the coil wrapping process and save cost.

In order to further appreciate the characteristics and technical contents of the instant disclosure, references are hereunder made to the detailed descriptions and appended drawings in connection with the instant disclosure.

However, the appended drawings are merely shown for exemplary purposes, rather than being used to restrict the scope of the instant disclosure.

### BRIEF DESCRIPTION OF THE DRAWINGS

FIG. 1 is an exploded view of a transformer for a first embodiment of the instant disclosure.

FIG. 2 is another exploded view of the transformer for the first embodiment of the instant disclosure.

FIG. 3 is yet another exploded view of the transformer for the first embodiment of the instant disclosure.

FIG. 4 is an assembled view of the transformer for the first embodiment of the instant disclosure.

FIG. 5 is an exploded view of a transformer for a second embodiment of the instant disclosure.

FIG. 6 is another exploded view of the transformer for the second embodiment of the instant disclosure.

FIG. 7 is yet another exploded view of the transformer for the second embodiment of the instant disclosure.

FIG. 8 is an assembled view of the transformer for the second embodiment of the instant disclosure.

### DETAILED DESCRIPTION OF PREFERRED EMBODIMENTS

### First Embodiment

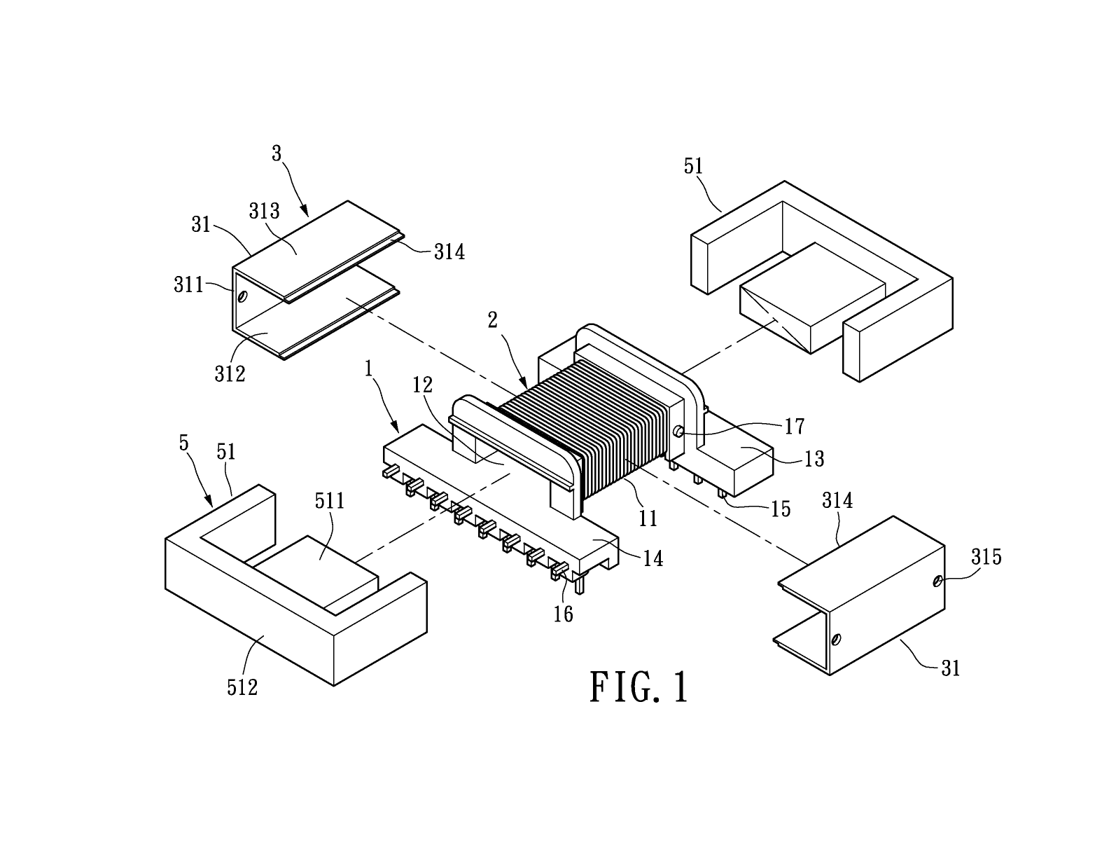

Please refer to FIGS. 1 to 4. The instant disclosure provides a transformer, which comprises a winding frame 1, a primary coil 2, an insulating cover 3, a secondary coil 4, and a core assembly 5. The winding frame 1 is made of insulating material such as plastic. The winding frame 1 has a hollowed winding portion 11 formed with a thru hole 12. The central axis of the winding portion 11 extends horizontally. A first side portion 13 and a second side portion 14 are formed oppositely on the winding portion 11. A plurality of first pins 15 and a plurality of second pins 16 are disposed on the first side portion 13 and the second side portion 14, respectively. The first and second pins 15 and 16 may be shaped in a right angle or have multiple curved sections. The structural configuration of the winding frame 1 is not restricted but can be varied according to the application.

As shown in FIG. 1, the primary coil 2 is wrapped around the winding portion 11 of the winding frame 1. The primary coil 2 is also connected to the first pins 15.

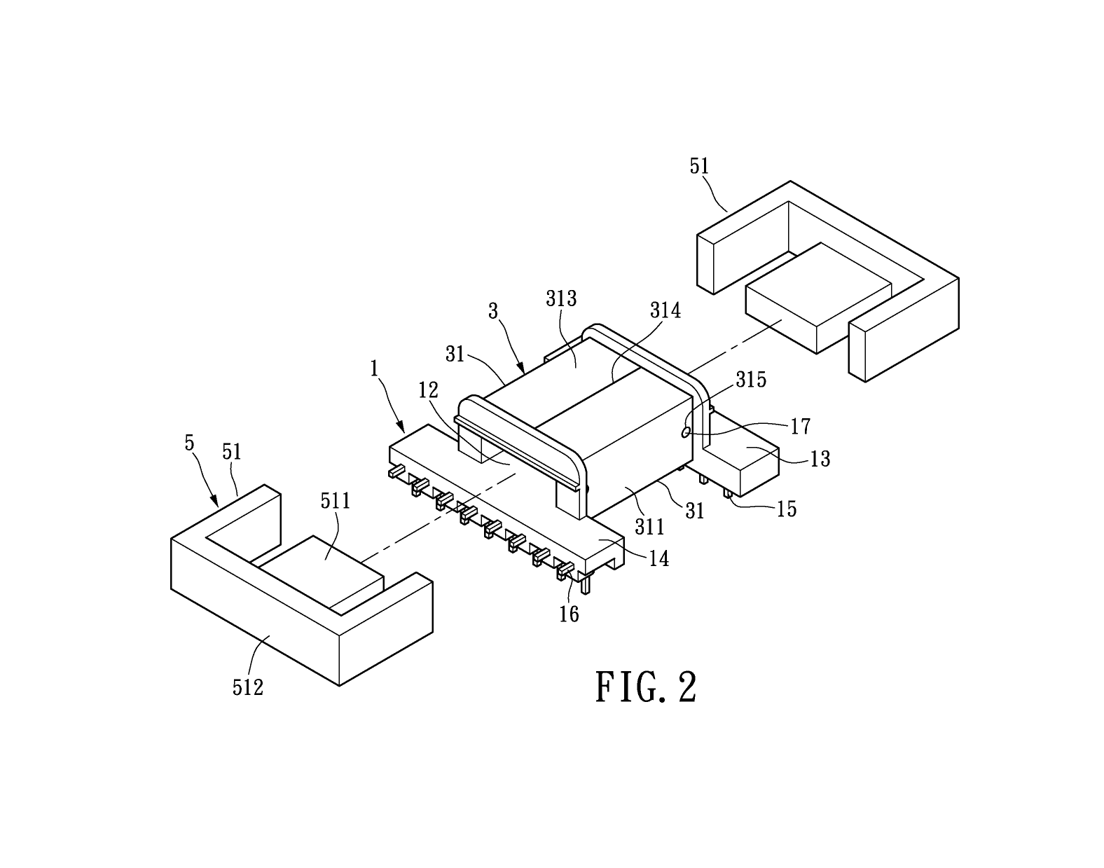

The insulating cover 3 is made of insulating material such as plastic. The insulating cover 3 can be divided into two halves or more. For the instant embodiment, the insulating cover 3 has two half shells 31. Each half shell 31 has a side wall 311, a bottom wall 312 extended from the bottom edge of the side wall 311, and a top wall 313 extended from the top edge of the side wall 311. The two half shells 31 can be matchingly engaged by the bottom walls 312 and the top walls 313, thus producing a complete insulating cover 3. As shown in FIG. 2, the insulating cover 3 is fitted over the primary coil 2. An engaging portion 314 may be formed on the connecting portion of each half shell 31 to ensure the two half shells 31 are in intimate contact with one another. Alternatively, a locking portion (not shown) may be formed on the connecting portion of each half shell 31 to secure the half shells 31.

For the instant embodiment, a fixing structure is further disposed between the winding frame 1 and the insulating cover 3. Namely, at least one engaging member 17 is protrudingly disposed on the winding frame 1. At least one fixing hole 315 is disposed correspondingly on the insulating cover 3. The fixing hole 315 can be secured matchingly to the engaging member 17, thus together in forming the aforementioned fixing structure. Thereby, the insulating cover 3 can be fastened securingly onto the winding frame 1. Alternatively, at least one locking hole (not shown) can be formed on the winding frame 1, and at least one locking member (not shown) can be disposed correspondingly on the insulating cover 3. Thus, an alternative fixing structure can be formed by the engagement between the locking hole and the locking member. A screw or adhesive-type fixing structure may also be employed. The type and structural configuration of the fixing structure, along with the insulating cover 3, are not restricted but can be varied according to the application.

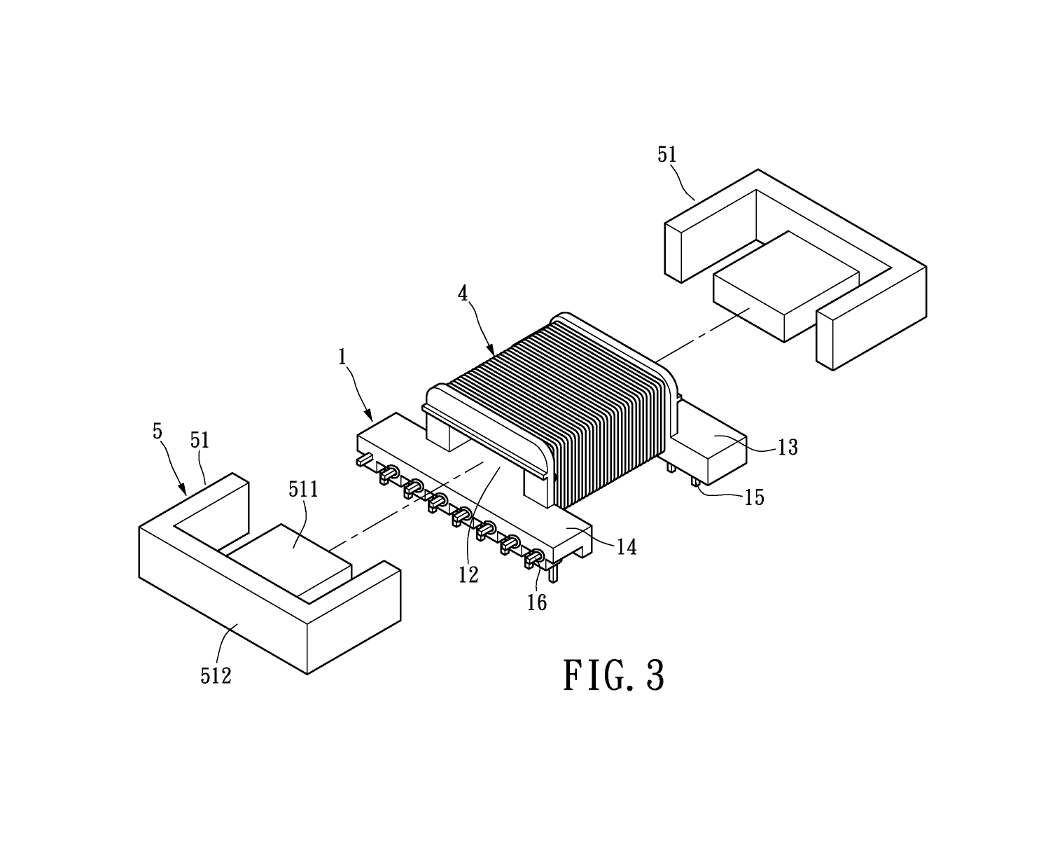

As shown in FIG. 3, the second coil 4 is wrapped around the insulating cover 3 and connected to the second pins 16. More specifically, the secondary coil 4 is wrapped around the side walls 311, the bottom walls 312, and the top walls 313 of the two half shells 31 of the insulating cover 3.

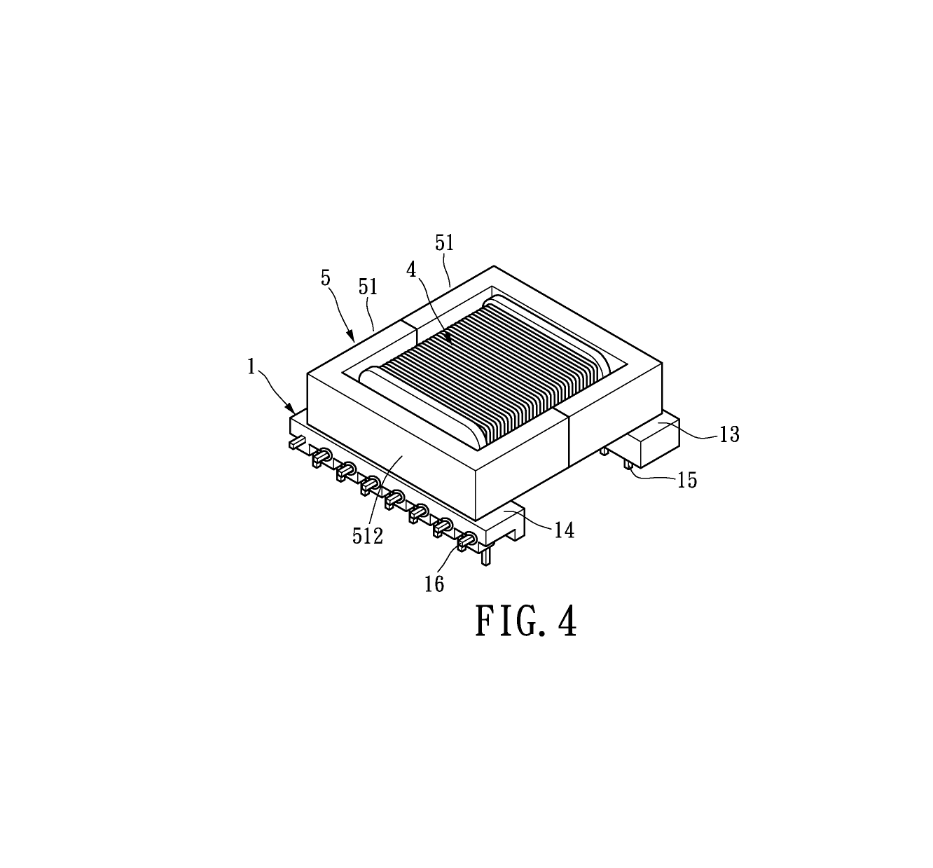

The core assembly 5 can be arranged on the winding frame 1. The core assembly 5 comprises a pair of cores 51 (such as E-shaped). The cores 51 are arranged on respective sides of the winding portion 11 of the winding frame 1. Each core 51 has an inner portion 511 for inserting into the thru hole 12 of the winding frame 1, and has an outer portion 512 exposed from the winding portion 11 in forming a magnetic circuit with the inner portion 511. As shown in FIG. 4, the outer portion 512 of each core 51 is arranged around the secondary coil 4. The structural configuration of the core assembly 5 is not restricted but can be varied according to the application.

The instant disclosure also provides an assembling method of the transformer. First, the winding frame 1 having the winding portion 11 is provided. The winding portion 11 is formed with the first side portion 13 and the second side portion 14 on opposite sides. First pins 15 are disposed on the first side portion 13, and second pins 16 are disposed on the second side portion 14.

Next, the primary coil 2 is wrapped around the winding portion 11 of the winding frame 1, and the primary coil 2 is connected to the first pins 15.

Next, the insulating cover 3 is fitted over the primary coil 2.

Next, the secondary coil 4 is wrapped around the insulating cover 3, and the secondary coil 4 is connected to the second pins 16.

Then, the core assembly 5 is arranged onto the winding frame 1.

### Second Embodiment

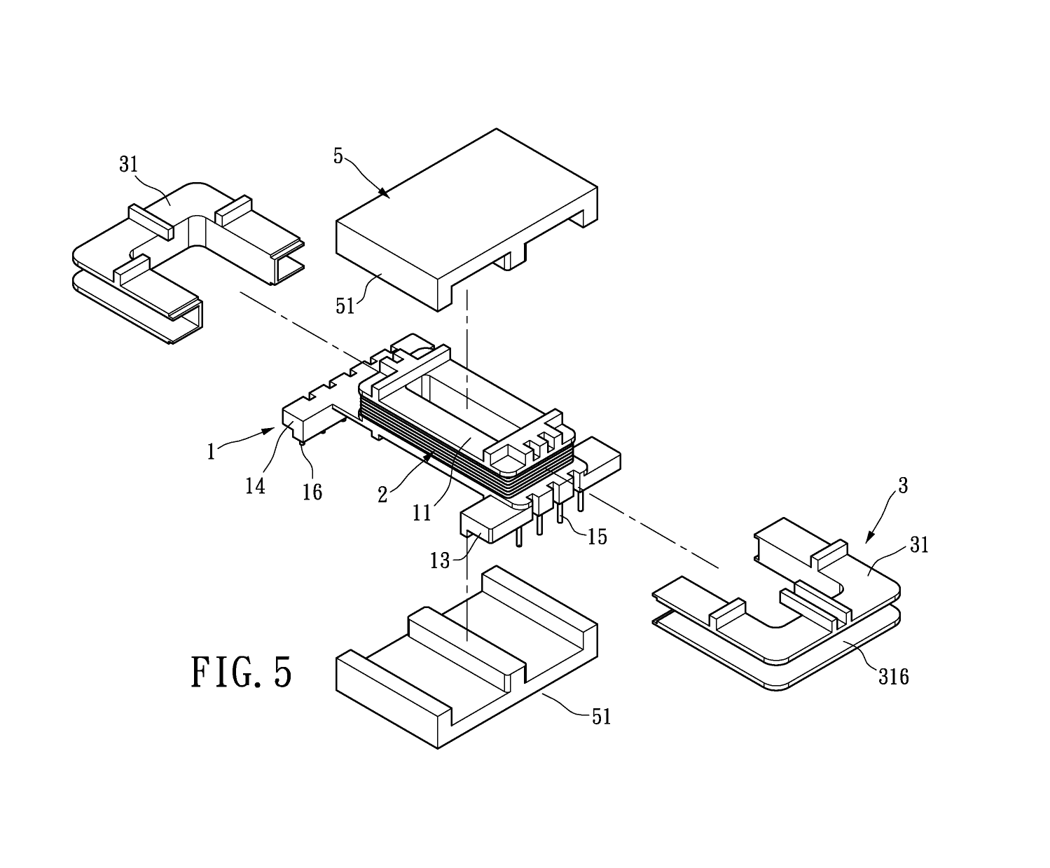

Please refer to FIGS. 5 to 8, which show another embodiment of the transformer of the instant disclosure. The technical features of the second embodiment are similar to the first embodiment. For the second embodiment, the transformer comprises the winding frame 1, the primary coil 2, the insulating cover 3, the secondary coil 4, and the core assembly 5. The winding frame 1 is formed with the winding portion 11. The central axis of the winding portion 11 extends in the vertical direction. The winding portion 11 is formed with first side portion 13 and the second side portion 14 on opposite sides. The first pins 15 and second pins 16 are disposed on the first side portion 13 and the second side portion 14, respectively.

As shown in FIG. 5, the primary coil 2 is wrapped around the winding portion 11 of the winding frame 1, and the primary coil 2 is connected to the first pins 15.

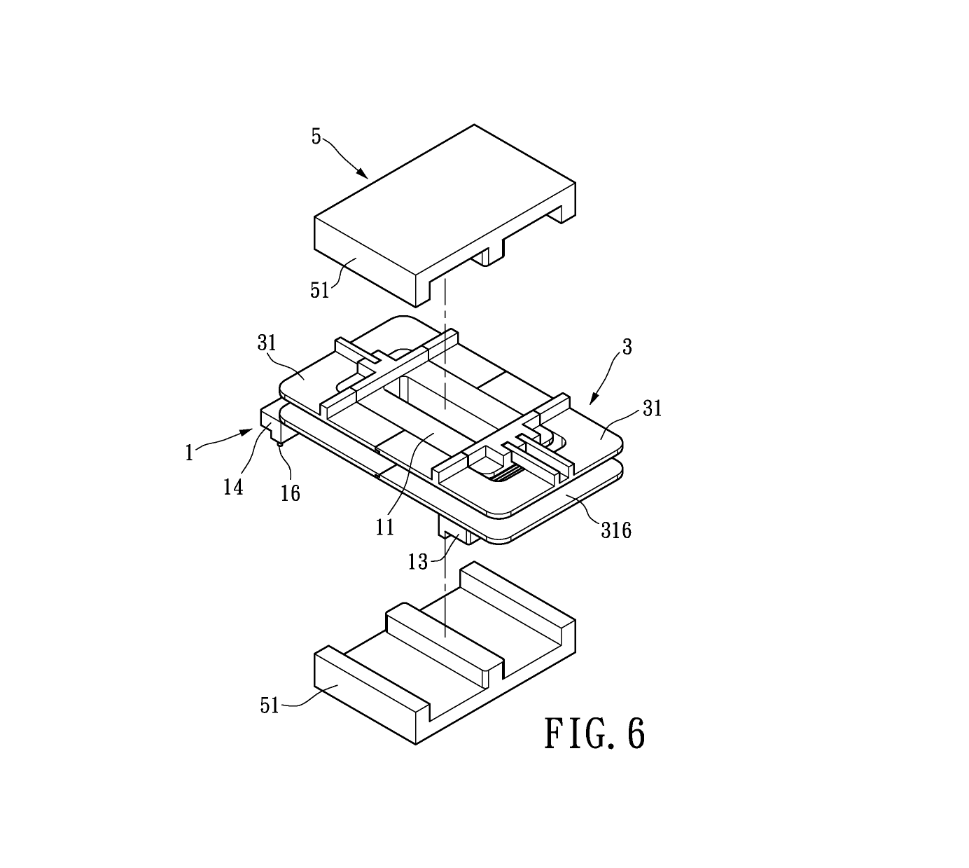

For the instant embodiment, the insulating cover 3 has a pair of U-shaped half shells 31. The two half shells 31 make up a complete insulating cover 3 for fitting over the primary coil 2 as illustrated in FIG. 6. A groove 316 is formed on periphery of the insulating cover 3.

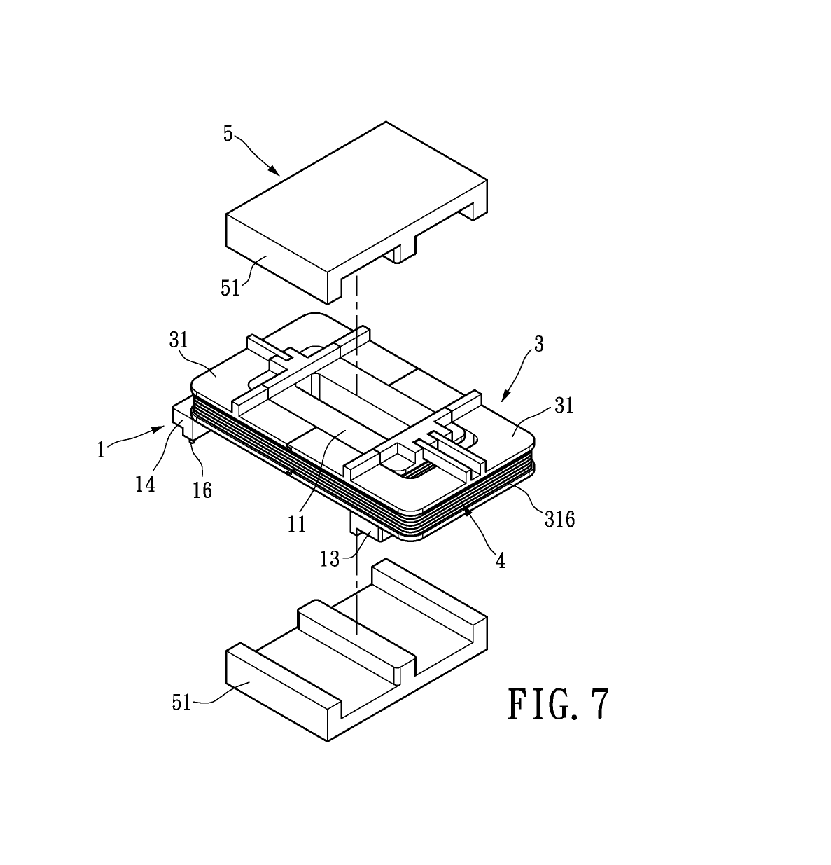

As shown in FIG. 7, the secondary coil 4 is wrapped around the insulating cover 3. More specifically, the secondary coil 4 is wrapped in the groove 316 of the insulating cover 3, and the secondary coil 4 is connected to the second pins 16.

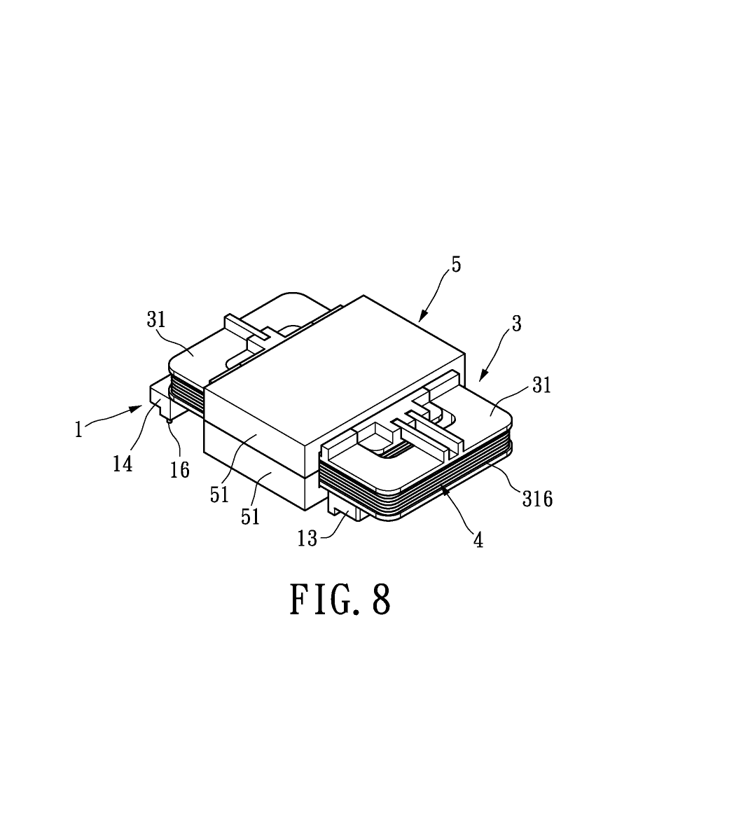

The core assembly 5 may include a pair of C-shaped cores 51. The cores 51 are arranged on opposite sides of the winding portion 11 of the winding frame 1. As shown in FIG. 8, the winding frame 1, the primary coil 2, the insulating cover 3, and the secondary coil 4 are surrounded by the core assembly 5.

The instant disclosure employs the insulating cover 3 to separate the primary coil 2 from the secondary coil 4. The insulating cover 3 can be fitted over the primary coil 2 very easily, without wrapping any insulating tape. In addition, a fully automatic winding machine can be used to wrap the primary coil 2 and the secondary coil 4 all in one step. The above capabilities expedite the coil wrapping process and save cost.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A transformer, comprising:
a winding frame having a winding portion, a first side portion and a second side portion oppositely arranged on two sides of the winding portion, wherein a plurality of first pins are disposed on the first side portion, wherein a plurality of second pins are disposed on the second side portion;
a primary coil windingly disposed on the winding portion of the winding frame and connected to the first pins;
an insulating cover shieldingly disposed over the primary coil;
a secondary coil windingly disposed on the insulating cover and connected to the second pins; and
a core assembly arranged on the winding frame.

2. The transformer of claim 1, wherein a central axis of the winding portion extends horizontally or vertically.

3. The transformer of claim 1, wherein the insulating cover has two half shells matchingly engaged, and wherein an engaging portion is disposed on the connecting portion of each half shell.

4. The transformer of claim 3, where each half shell has a side wall, a bottom wall extends laterally from the bottom edge of the side wall, and a top wall extends laterally from the top edge of the side wall, and wherein the two half shells are engaged through the side walls, the bottom walls, and the top walls.

5. The transformer of claim 1, wherein a groove is formed on the periphery of the insulating cover, and wherein the secondary coil is wrapped in the groove of the insulating cover.

6. The transformer of claim 1, wherein a fixing structure is formed between the winding frame and the insulating cover.

7. The transformer of claim 6, wherein at least one engaging member is disposed protrudingly on the winding frame, wherein at least one fixing hole is formed correspondingly on the insulating cover, and wherein the engaging member is secured to the fixing hole to form the fixing structure.

8. A transformer assembling method, comprising the steps of:
providing a winding frame, wherein the winding frame has a winding portion, a first side portion, and a second side portion, and wherein a plurality of first pins are disposed on the first side portion with a plurality of second pins disposed on the second side portion;
wrapping a primary coil around the winding portion of the winding frame and connecting the primary coil to the first pins;
fitting an insulating cover over the primary coil;
wrapping a secondary coil around the insulating cover and connecting the secondary coil to the second pins; and
arranging a core assembly on the winding frame.

9. The transformer assembling method of claim 8, wherein the insulating cover has two half shells matchingly engaged, and wherein an engaging portion is disposed on the connecting portion of each half shell.

10. The transformer assembling method of claim 8, wherein a fixing structure is formed between the winding frame and the insulating cover to secure the insulating cover onto the winding frame.
